(19) United States
(12) Patent Application Publication
(10) Pub. No.: US 2025/0242963 A1
(43) Pub. Date: Jul. 31, 2025

(54) TRANSPARENT CELLULOSIC PACKAGING

(71) Applicant: SOCIETE DES PRODUITS NESTLE S.A., Vevey (CH)

(72) Inventor: KARIM MISSOUM, Pusignan (FR)

(21) Appl. No.: 18/855,951

(22) PCT Filed: Apr. 12, 2023
(86) PCT No.: PCT/EP2023/059473

§ 371 Date: Oct. 10, 2024

(30) Foreign Application Priority Data
Apr. 13, 2022 (EP) 22168096.0

(51) Int. Cl. B65D 5/42; B65D 25/54; B65D 33/04; B65D 75/52; D21H 17/36; D21H 17/37; D21H 27/06; D21H 27/10

(52) U.S. Cl. CPC B65D 5/4204; B65D 25/54; B65D 33/04; B65D 75/522; D21H 17/36; D21H 17/37; D21H 27/06; D21H 27/10

(57) ABSTRACT

The invention is directed to a three-dimensional food packaging (100) having a packaging interior (V) and being made of a cellulosic fibrous material (200). At least a portion (111) of the food packaging (100) delimiting at least part of the packaging interior (V) is impregnated with a polymer (300) such that the impregnated portion (111) has a light transmittance above 60% for visible light.

### FIELD OF THE INVENTION

The present invention relates to a food packaging being made of a fibrous cellulose-based material having a high level of transparency.

### TECHNICAL BACKGROUND

Packages for packing edible products for human or animal consumption made of cellulose pulp, like paper or cardboard, or made by molding a cellulosic slurry, are known in the field of packaging. Therein, it is also known that such cellulosic material can be chemically or mechanically treated—or combined with another material—to provide a package with barrier properties like a barrier to liquids, moisture, or oxygen to ensure that the qualities of the packaged product are maintained over a defined period of time.

Cellulosic materials can be manufactured from wood, for example. While wood as such cannot be used for forming packages, it can be transformed through a series of chemical and mechanical treatments, in which undesired wood components, like lignin, are removed and subsequently a cellulosic material can be obtained that can be transformed into packages. These cellulose-based packages have a reduced environmental impact compared to packages made of other materials presently used for packages, such as petroleum plastics, because cellulose-based packages can be manufactured from renewable resources, and also, recycling processes for such materials are available in most countries, well known and cost efficient.

However, a drawback of cellulosic materials, such as paper, cardboard, or mouldable cellulose pulp, is their lack of transparency. This is particularly problematic for packaging edible products, because consumers want to visually control the type, quantity and quality of the product inside the packaging without having to open it for this purpose. Moreover, transparency of packaging could also be used for ripening fruit or vegetables inside the packaging or to activate the emission of flavors, aromas or odors on exposure to light, such as sunlight.

As a solution for overcoming the lack of transparency of packages, cellulose-based packages are often combined with different but transparent materials, such as (petroleum based) plastic films, to create see-through windows in the package. However, such “hybrid” packaging solutions are not suitable for seamless recycling because they generally necessitate that each different type of constituent of the packaging is separated by either the consumer or the recycling facility as it is not possible to recycle the cellulosic part together with the plastic material. From this, it is clear that the disposal and recycling process for such hybrid packaging solutions can be relatively complex and cost intensive and thus, disadvantageous.

Accordingly, attempts were made in the prior art to treat cellulosic material to achieve a certain level of transparency. For this, relatively thin layers of paper, e.g. papers having a grammage of 30 g/m² (gsm) and below, had to undergo chemical treatment. However, none of the prior art attempts resulted in a material having transparency. Instead, only translucence was achieved, which, unlike transparency, allows merely to distinguish a product through the package wall, but the visual presentation of the product remains blurry and undefined. In comparison, transparency refers to the optical distinctness with which an object can be seen when viewed through a material.

Thus, translucent paper still lacks transparency as a majority of the light travelling through the paper is blocked or randomly dispersed leading to a blurry view of the packaged items without sight sharpness. In addition, it was found that while a relatively low thickness of the paper material may be usable in some specific packaging applications, such as overwrapping individual candies or chocolates, for most food packaging purposes such thicknesses pose a number of challenges due to a relatively low elongation at break and lack of mechanical resistance of the material, which also increases the complexity of packaging food items in machines.

Further attempts were made, for instance, by Feixiang Guan et Al. in the Journal of Bioresources and Bioproducts (volume 5, issue 1, February 2020, Pages 37-43) where a conventional paper was chemically treated to achieve a transmittance of more than 90% at 550 nm. While the results obtained are promising in terms of transparency, the chemical treatment necessary is not feasible to come into contact with edible products, because of the high toxicity of the chemicals required. Instead, the resulting paper is intended to act as an alternative substrate in fabrication of flexible electronics. Accordingly, the issue of providing a recyclable food packaging with a defined level of transparency remains unresolved.

Therefore, it is an object of the invention to provide a packaging from cellulosic fibres, the packaging having a high level of transparency, being food safe, being able to be made sufficiently stiff or stretchable (until break) to allow machine manufacturing of rigid as well as flexible packages (e.g. a tray or pouch) therefrom, and being recyclable in the paper stream process. Advantageously, the packaging can be provided with barrier properties to oxygen, grease and/or moisture transfer also.

These and other objects, which become apparent upon reading the description, are solved by the subject-matter of the independent claim. The dependent claims refer to preferred embodiments of the invention.

### SUMMARY OF THE INVENTION

An aspect of the invention relates to a three-dimensional food packaging. The food packaging is made of a cellulosic fibrous material. The food packaging defines a packaging interior. At least a portion of the food packaging, which portion delimits at least part of the packaging interior, is impregnated with a polymer such that the impregnated portion has a (direct) light transmittance above 60% for visible light.

With this packaging, it becomes possible, for example, to enclose a food item inside a package, container, capsule, pouch, or wrapping that may form an outer shell for conserving said food item inside its interior and that may extend in all three dimensions (preferably such that its extension in each dimension may be noticeable in relation to the other extensions). For example, the packaging may be a voluminous body (rather than extending primarily within a single plane). As a food packaging, the packaging may be designed such that it is safe to come into direct contact with food items (food products).

Accordingly, with the food packaging it becomes possible to provide a free space inside the food packaging (concealed from the outside by the packaging), which allows to receive and store a food item safely over the entire intended product shelf-life.

By providing the food packaging from a cellulosic fibrous material, i.e. a material that may contain, consist of, or resemble fibres and/or that may be capable of being separated into fibres, and that may comprise and/or may be made from cellulose, it becomes possible, for example, to produce the food packaging (exclusively) from sustainable sources and to allow for recycling (e.g. EN13430 standard) or even to compost (e.g. EN13432 standard) the (entire) food packaging after its use. Additionally, the mechanical strength and rigidity of the food packaging can be tailored to the application by adapting parameters of the cellulosic fibrous material, for instance.

By a section or part of the food packaging being impregnated with a polymer, which part, for example, may form a part of the shell enclosing the packaging interior, it becomes possible to adapt the material characteristics of the food packaging by introducing and integrating a defined quantity of a substance into the cellulosic fibrous material. For example, in the impregnation process, the polymer may be transported in gaps between the fibres of the cellulosic fibrous material and thereby, may be absorbed by the cellulosic fibrous material. Thus, depending on the polymer, the characteristics of the impregnated portion can be varied. For example, the polymer can be used to modify the light scattering behaviour of the cellulosic fibrous material of the food packaging, such as the behaviors relating to clarity (e.g. relevant for optical sharpness and determined as a percentage of light, which, when passing through the material, deviates from the incident beam less than 2.5 degree), haze (e.g. relevant for contrasts and determined as a percentage of light, which, when passing through the material, deviates from the incident beam greater than 2.5 degree) and transmission (e.g. relevant for light intensity).

In particular, said portion of the food packaging is impregnated with the polymer such (e.g., in a manner, way, to an extent, and/or with the consequence) that the so impregnated portion can have a (direct) luminous transmittance/transmission that is above 60%.

Therein, the (direct) light transmittance is determined as the fraction of the amount of luminous energy (luminous flux) passing through the material of the impregnated portion without being scattered or by only negligibly (e.g. below 2.5 angular degrees) being scattered, to the amount of luminous energy (luminous flux) emitted by the light source incident on said impregnated portion, expressed as a percentage. Preferably, light can pass through the impregnated portion irrespective of its general travelling direction, i.e. the amount of light that can pass from the packaging interior to the outside of the food packaging may be the same or at least similar to the amount of light that can pass from the outside of the food packaging to the packaging interior. Furthermore, the light transmittance value may relate to light comprising light waves in the visual spectrum, i.e. having a wavelength spectrum that corresponds to the one of light visible with human eyes, which may be between 300 nm and 800 nm, preferably between 370 nm and 780 nm.

It was found that transparency is dependent on light passing through the material substantially without being deflected as even small deflections may cause a deterioration of the visual impression (e.g. quantitatively expressed with haze and/or clarity). Therein, the inventor has surprisingly found that by generating in the above-described manner a food packaging with the claimed level of light transmittance, it is possible to provide the food packaging with a transparent portion having a quality, which facilitates that the packaged food item in the packaging interior can be viewed from the outside through the material of the food packaging with optical distinctness across a high variety of different food packaging applications (e.g. from coffee capsules to food trays or even to water bottles). In comparison, with translucent packages known from the prior art, the food items cannot be distinctly and clearly seen through the material. Moreover, it was found that porosity of the cellulosic fibrous material can be reduced so that light diffusion can be increased, thereby also contributing to the transparency of the food packaging. Thus, the food packaging of the present invention provides a solution to the above-described technical problems existing in the prior art.

According to a preferred embodiment, the impregnated portion may have a (direct) light transmittance above 65%, or above 70%, or above 75%, or above 80%, or above 85%, or above 90%, or above 95%, or 100% for visible light. Alternatively or additionally, haze (e.g. corresponding to the (direct) transmittance value) may be below 30%, or below 20%, or below 10%. Alternatively or additionally, clarity (e.g. corresponding to the (direct) transmittance value) may be above 50%, above 60%, above 70%, above 80%, above 90% or above 95%.

Thereby, it is possible to improve the optical distinctness, with which the packaged food item in the packaging interior can be viewed from the outside through the material of the food packaging. Therein, it has been found that the level of light transmittance of existing prior art translucent paper materials for food packaging either cannot be increased to or beyond the above claimed level, or it would not be economically viable to get such paper materials to such level.

According to a further preferred embodiment, the polymer may be a food grade material. Alternatively or additionally, the polymer may be a bioplastic, and/or the polymer may be compostable and/or biodegradable. However, it is also conceivable that the polymer may be a non-biodegradable polymer or a polymer derived from petroleum.

Therein, the expression “food grade material” may be understood as meaning a material that is safe either for human consumption or to come into direct (i.e. immediate, unobstructed) contact with food items.

Further, the term “compostable” may be understood as meaning that a material may be substantially broken down into organic matter within a few weeks or months when it is composted. This may be accomplished in industrial composting sites and/or home composters. Specific conditions relating to wind, sunlight, drainage and other factors may exist at such sites. At the end of a composting process, the earth may be supplied with nutrients once the material has completely broken down. International standards, such as EU 13432 or US ASTM D6400, provide a legal framework for specifying technical requirements and procedures for determining compostability of a material.

In comparison, the expression “biodegradable material” may be understood as any material that can be broken down into environmentally innocuous products by (the action of) living things (such as microorganisms, e.g. bacteria, fungi or algae). This process could take place in an environment with the presence of oxygen (aerobic) and/or otherwise without presence of oxygen (anaerobic).

Thereby, it is possible to provide the entire food packaging from materials that are not only compatible to come into contact with food but also are suitable to be composted and thus, reduce the ecological footprint of the food packaging.

According to a preferred embodiment, the polymer may have a refractive index similar or identical to the cellulosic fibrous material. However, it is also conceivable that the refractive index of said two materials may be differ from each other. Preferably, the absolute difference between the refractive indices may be below 30%, or below 20%, or below 10% of the refractive index of the cellulosic fibrous material.

Therein, the refractive index of a material may be understood, for example, as a dimensionless parameter describing the speed of light travelling through the material. The refractive index of paper may be around 1.5, for example.

Thereby, it is possible to improve the degree of transparency of the food packaging even further since the impregnated portion can be exclusively provided from components with a uniform or at least similar refractive index (unlike a translucent material that may comprise components with different refractive indices). In particular, tailoring the refractive index of the polymer to the refractive index of the cellulosic fibrous material may lead to optimal optical sharpness trough the food packaging material without any distortion of the light. In comparison, differences in the refractive index may reduce the optical sharpness.

According to a further preferred embodiment, the polymer may comprise Polyolefin, Polyacrylate, Polycaprolactone, Polyester, Polyalcohol, Polyhydroxyalkanoate, thermoplastic starch, cellulose derivative, Epoxy resin, or any combination thereof.

With anyone of the above polymers, it is possible to impregnate the cellulosic fibrous material such that the food packaging can be provided with the desired transparency level. In particular, neither food safety nor biodegradability or compostability of the food packaging may be compromised by using any of these types of polymers.

According to a preferred embodiment, the impregnated portion may comprise a concentration of the polymer that may be continuous or at least partially continuous. Alternatively or additionally, the impregnated portion may comprise a concentration of the polymer that may vary along at least one of its extension directions. For example, the concentration of the polymer at the impregnated portion may vary between the packaging interior and the side opposite thereto. Preferably, the impregnated portion may comprise between 0.5 wt % to 20 wt % of the polymer with respect to the weight of the corresponding section of the cellulosic fibrous material. More preferred, the impregnated portion may comprise between 1 wt % to 15 wt % of the polymer with respect to the weight of the corresponding section of the cellulosic fibrous material.

Thereby, it is possible to provide the food packaging with varying levels of transparency or to alternate between opaque, translucent and transparent sections. In addition, it is possible to use a localized high concentration of the polymer for providing additional functionality, such as sealing or barrier functions. Furthermore, this also allows, for example, to transform the food packaging material from a flat sheet into a tri-dimensional packaging by forming and sealing the same.

According to a further preferred embodiment, the impregnated portion may comprise at least one sealing portion for sealing the impregnated portion. Preferably, the polymer may be suitable for heat sealing and/or ultrasonic sealing. The sealing portion may have a concentration of the polymer that allows for sealing the impregnated portion by heat sealing and/or ultrasonic sealing. The sealing portion may be provided at one side of the impregnated portion that may comprise a higher concentration of the polymer than a respective other opposite side. For example, polyethylene may be used for the purpose of sealing the impregnated portion.

Thereby, the material of the food packaging can be sealed on a side having a localized high concentration of a sealable polymer so that the food packaging material can be sealed to other sealing portions provided on the food packaging or to other elements forming the finished food packaging (e.g. a lid). Accordingly, manufacturing of the food packaging can be simplified and the freedom in designing the food packaging can be increased. Additionally, it was found that the bond strength between sealing portions can be improved with such configuration.

According to a preferred embodiment, the food packaging may comprise a plurality of the impregnated portions. Preferably, at least some of the impregnated portions may be separated from each other by one or more sections of the food packaging comprising a lower or no concentration of the polymer in comparison to said impregnated portions. Preferably, the impregnated portion may extend across the entire food packaging.

Thereby, it is possible, for example, to provide the food packaging with multiple windows or one continuous window to display the packaged food item from different sides or angles. In addition, it is also possible to protect light sensitive portions of the packaged food from the light while less sensitive portions of the packaged food item can be still displayed.

According to a further preferred embodiment, the food packaging may have an oxygen barrier, a grease barrier, and/or a moisture barrier. Alternatively or additionally, at least the impregnated portion may comprise an oxygen barrier, a grease barrier, and/or a moisture barrier. Preferably, the oxygen barrier may comprise an oxygen transmission rate (OTR) below 5 cm³/m²/day. The moisture barrier may comprise a moisture transmission rate (MVTR) below 5 g/m²/day.

Therein, the OTR may be a measure of the amount of oxygen gas that passes through a substance over a defined period. For example, OTR may be measured using known methods specified in industrial standards, such as DIN 53380-3, ASTM D1434 or ISO 2872.

Further, the MVTR may be a measure of the passage of moisture (e.g. water vapour) through the material of the food packaging. For example, the MVTR may be measured using known methods specified in industrial standards, such as ISO 2528, ASTM E96, ASTM D1653, or TAPPI T464 (e.g. based on gravimetric method).

Thereby, it is possible to provide the food packaging with the capability to preserve the integrity and quality of the packaged food item inside the packaging interior over the intended shelf-life.

According to a preferred embodiment, the food packaging and/or at least the impregnated portion may have a thickness that is of 5 microns or above, 40 microns or above, 0.1 mm or above, 0.5 mm or above, 1 mm or above, 2 mm or above, 3 mm or above, 4 mm or above, 5 mm or below, 4 mm or below, 3 mm or below, 2 mm or below, 1 mm or below, 0.5 mm or below, 0.1 mm or below, or 40 microns or below, or the food packaging and/or at least the impregnated portion may have a thickness according to any combination of any of the aforementioned upper and lower limits.

Thereby, it is possible to provide the food packaging with the required mechanical stability and rigidity depending on the individual packaging application without having to compromise or abandon the benefits of having a transparent food packaging. In addition, a higher thickness of the food packaging material may lead to better barrier properties of the food packaging, which is beneficial for shelf-life.

According to a further preferred embodiment, the impregnated portion may be impregnated in a solid impregnation process.

Therein, a solid impregnation process may be understood as the polymer and the cellulosic fibrous material being each provided as a solid in the impregnation process. For example, the polymer may be provided as a powder, which preferably may have a homogeneous distribution that may vary from 100 nm to several (e.g. up to 10) microns (Gaussian curve distribution), which is “forced” into the cellulosic matrix of fibres, for example under application of high alternating voltage, such as to fill the empty spaces and gaps between the cellulosic fibres.

Thereby, it is possible to provide the food packaging with a uniform distribution of polymer particles and, unlike in a liquid impregnation process, no solvent is needed and thus, traces of a solvent cannot be found inside the material of the food packaging. Accordingly, the level of transparency can be improved and the risk of introducing non-food grade materials into the food packaging is reduced.

Alternatively or additionally, it is conceivable to use a liquid impregnation process. In this process, polymers are dissolved in a solvent, such as acetone, chloroform dichloromethane, that is applied to the cellulosic fibrous material for impregnation. For example, the choice of solvent may depend on the type of the polymer used. Thereby, the solvent containing the polymer may be absorbed by the cellulosic fibrous material. Alternatively or additionally, vacuum impregnation may be used.

According to a preferred embodiment, the cellulosic fibrous material may comprise paper, paperboard, a cellulosic pulp adapted for being molded, a cellulose nanofibres sheet or film, airlaid cellulose and/or delignified wood.

Thereby, the food packaging can be provided from a variety of sustainable, recyclable, biodegradable, compostable and/or food-compatible materials. In addition, each of the materials allows to design the shape of food packaging freely.

According to a further preferred embodiment, the food packaging (e.g. entirely/as a whole) may comprise more than 70 wt % or 75 wt % or 80 wt % or 85 wt % or 90 wt % or 95 wt % of cellulose. Alternatively or additionally, the food packaging may be recyclable. For example, the food packaging may be recyclable in the paper recycling stream. Alternatively or additionally, the (entire) food packaging may be biodegradable.

Therein, expression “recyclable” may be understood, for example, as a material that can be reused (entirely) for a new product or purpose after having been treated mechanically or chemically using an industrial or natural process. For example, the materials used for the food packaging may be collected after usage and may be mixed with water and chemicals to break it down. It is heated up and broken up into strands of cellulose. Plastic coatings and ink may be removed as long as they do not exceed a certain amount. For example, to recycle a paper material successfully, the amount of polymer content in the recyclable material may only be up to about 5% (or preferably, even up to 20%) of its total weight. Industrial standards, such as EN 13430, ISO 15270 and ISO 14001, relate to requirements defined for industrial recycling practice.

In a paper recycling stream, the material composition of the food packaging as the waste material may, for example, undergo a process (such as re-pulping into fibres) to obtain a material, namely the recyclate, that can be used for a purpose, such as for making another item (such as a sheet of paper, not necessarily another food packaging).

Thereby, it is possible to provide the food packaging with a high cellulose content, which facilitates that the food packaging can be considered biodegradable and/or particularly suitable for being recycled in the paper recycling stream of most countries around the world.

According to a preferred embodiment, the impregnated portion may form at least one window for displaying a food product being placed inside the food packaging into the packaging interior.

Thereby, consumers can visually control the type, quantity and quality of the food product through the window in the food packaging without having to open it.

According to a preferred embodiment, the food packaging may comprise at least one packaging wall defining a body of the food packaging. Preferably, the packaging wall may define a rigid or flexible body of the food packaging. The body of the food packaging may delimit the packaging interior. Preferably, the food packaging may comprise a grammage between 30 g/m² and 800 g/m². Alternatively or additionally, if present, the at least one packaging wall may comprise a grammage between 30 g/m² and 800 g/m².

Therein, the term “rigid” may be understood as an ability of the material to resist deformation in response to an applied mechanical load; e.g. the load resulting from a food item being filled in the packaging interior or a gripping force of a user to grasp and carry the filled food packaging. This ability may preferably originate from a compactness of the material of the packaging wall or it may be inherent to the body. For example, the packaging wall may comprise a thickness or density that facilitates the material being mechanically inflexible to a certain extent. For fibre-based materials, for example, the bending stiffness may be determined in tests following ISO 2493. For example, the rigid body may comprise a bending stiffness between 400 Nm and 3500 Nm. The rigid body may preferably comprise a grammage between 30 g/m² and 800 g/m². Preferably, the rigid body may comprise a density in the range of 250 kg/m³ to of 1000 kg/m³. However, rigidity may be achieved not only structurally, for example by providing the food packaging with relatively thick walls or ribs, but also chemically, for example by providing the food packaging from a certain material or providing it with a certain coating or a laminate.

According to a further preferred embodiment, the at least one packaging wall may comprise the impregnated portion. Preferably, the impregnated portion may be integrally formed with the at least one packaging wall. Preferably, the food packaging may be provided as a single piece.

Thereby, a transparent portion can be provided as a window that is part of the same structure and material forming the food packaging. Thus, unlike in the prior art, it is not necessary to provide a window from a separate material capable of providing transparency. Accordingly, the recycling process of the food packaging can be significantly simplified. Also, the mechanical stability and barrier properties of the food packaging can be improved as the food packaging can be formed by only one or only a low number of components that are to be connected.

According to a preferred embodiment, the food packaging may be a tray, cup, (half-)bottle.

Therein, for example, a bottle may be considered a hollow narrow-necked container for holding liquids.

Thereby, it is possible to provide the food packaging in a form that is compatible with a high number of different food applications.

According to a further preferred embodiment, the food packaging may comprise a lid. Therein, the lid may preferably comprise the impregnated portion. Preferably, the packaging interior may be closed by the lid. For example, the packaging interior may be closed by the lid by applying heat sealing and/or ultrasonic sealing. For example, the lid may be a cap for a bottle or a preferably flat cover for a cup, bowl or tray.

Thereby, the food packaging can be closed off by a transparent cover at the top in the intended vending position. This is particularly advantageous for displaying the packaged food item and for presenting the food item in the supermarket.

According to a preferred embodiment, the food packaging may partially or fully and preferably sealingly enclose the packaging interior for containing an edible product for human and/or animal consumption. For example, the food product (food item) may be a liquid, semi-solid, or solid product. The food product may be in the form of powders, kibbles, paste, gels, and/or sauces. Alternatively or additionally, the food product may comprise or may be water.

Thereby, it is possible to provide a protective food packaging for a high number of different food items.

A further aspect of the invention relates to a food packaging material that is made of a cellulosic fibrous material and has a portion that is impregnated with a polymer such that the impregnated portion has a (direct) light transmittance above 60% for visible light. Preferably, the food packaging material may be formable to define a packaging interior of a food packaging, wherein more preferred the impregnated portion may at least partially delimit said packaging interior.

Preferably, the food packaging material may comprise a grammage between 30 g/m² and 800 g/m². More preferred, the food packaging material may have a grammage above 30 g/m², above 40 g/m², above 60 g/m², above 80 g/m², above 100 g/m², above 120 g/m², above 140 g/m², above 160 g/m², above 180 g/m², above 200 g/m², above 220 g/m², above 240 g/m², above 260 g/m², above 280 g/m², above 300 g/m², above 320 g/m², above 340 g/m², above 360 g/m², above 380 g/m², above 400 g/m², above 420 g/m², above 440 g/m², above 460 g/m², above 480 g/m², above 500 g/m², above 520 g/m², above 540 g/m², above 560 g/m², above 580 g/m², above 600 g/m², above 620 g/m², above 640 g/m², above 660 g/m², above 680 g/m², above 700 g/m², above 720 g/m², above 740 g/m², above 760 g/m², above 780 g/m², or of 800 g/m², and/or below 800 g/m², below 780 g/m², below 760 g/m², below 740 g/m², below 720 g/m², below 700 g/m², below 680 g/m², below 660 g/m², below 640 g/m², below 620 g/m², below 600 g/m², below 580 g/m², below 560 g/m², below 540 g/m², below 520 g/m², below 500 g/m², below 480 g/m², below 460 g/m², below 440 g/m², below 420 g/m², below 400 g/m², below 380 g/m², below 360 g/m², below 340 g/m², below 320 g/m², below 300 g/m², below 280 g/m², below 260 g/m², below 240 g/m², below 220 g/m², below 200 g/m², below 180 g/m², below 160 g/m², below 140 g/m², below 120 g/m², below 100 g/m², below 80 g/m², below 60 g/m², below 40 g/m², or of 30 g/m².

Preferably, a rigid packaging body may be formed from the packaging material. Naturally, it is conceivable that the food packaging material may comprise any one of the features described above for the food packaging of the first aspect of the invention.

Thereby, all effects and advantages described above for the food packaging can be equally obtained for the food packaging material.

Further features, advantages and objects of the invention will become apparent for the skilled person when reading the following detailed description of embodiments of the invention and when taking in conjunction with the figures of the enclosed drawings. In case numerals were omitted from a figure, for example for reasons of clarity, the corresponding features may still be present in the figure.

### BRIEF DESCRIPTION OF FIGURES

FIGS. 1 to 3 show schematic cross-sectional views of different steps of the impregnation process of a cellulosic fibrous material according to an embodiment of the invention.

FIGS. 4 to 7 show schematic front or side (FIG. 5) views of an impregnated portion according to different embodiments of the invention.

FIGS. 8 to 11 show schematic sectional views of different embodiments of the food packaging according to the invention.

### DETAILED DESCRIPTION OF THE INVENTION

The figures show different views and aspects of a three-dimensional food packaging 100 according to the present invention.

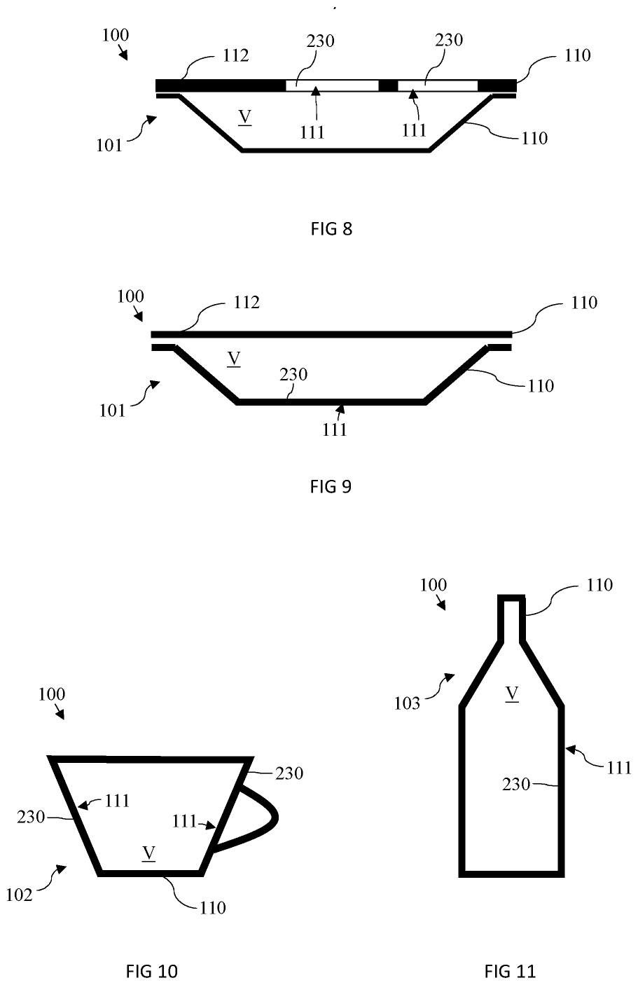

FIGS. 8 to 11 show different examples of the food packaging 100. For example, in FIGS. 8 and 9, the food packaging 100 is exemplarily illustrated as a tray 101, in FIG. 10, the food packaging 100 is exemplarily illustrated as a cup 102, and, in FIG. 11, the food packaging 100 is exemplarily illustrated as a bottle 103. However, this is not a complete enumeration and other embodiments of the food packaging 100 are conceivable, such as boxes, capsules or sachets, for example.

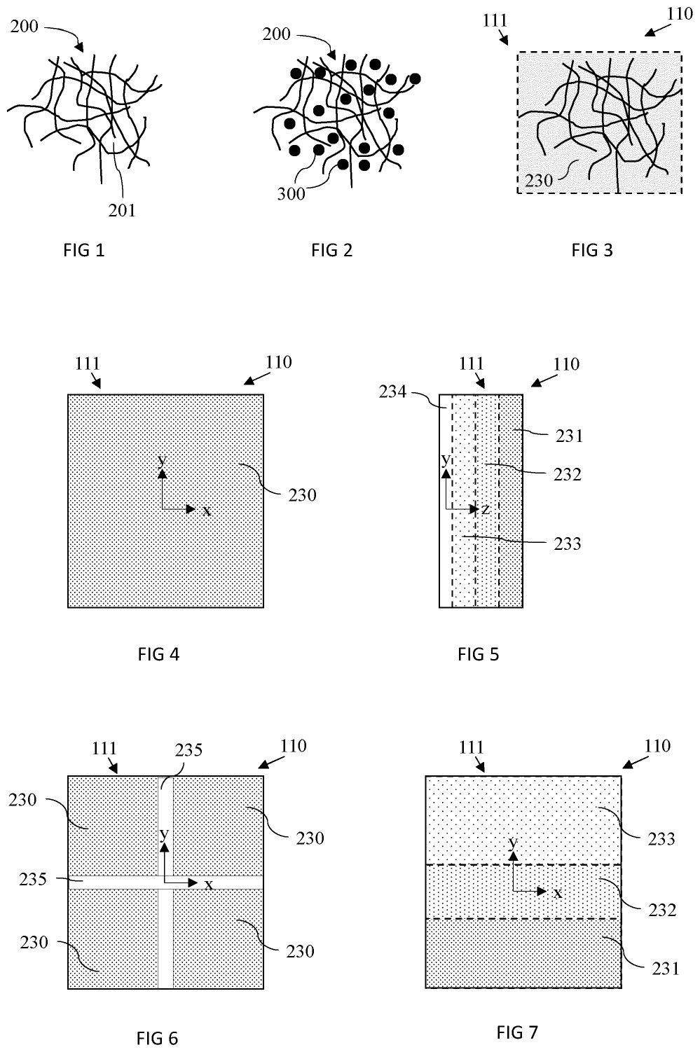

The three-dimensional food packaging 100 is made of a cellulosic fibrous material 200. This is exemplarily illustrated in FIG. 1. Therein, it is exemplarily shown that cellulosic fibres may form a matrix with gaps 201 therebetween. For example, the cellulosic fibrous material 200 may comprise or may be paper, paperboard, a cellulosic pulp adapted for being molded, a cellulose nanofibres sheet or a cellulose nanofibres film, airlaid cellulose and/or delignified wood.

The three-dimensional food packaging 100 defines a packaging interior V. This is exemplarily illustrated in FIGS. 8 to 11. The packaging interior may be suitable or configured for receiving a food item. The packaging interior V may be open or closed. For example, the food packaging 100 may at least partially enclose the packaging interior V as exemplarily illustrated in FIG. 10 or 11. Alternatively, the food packaging 100 may fully and preferably sealingly enclose the packaging interior V such as exemplarily illustrated in FIGS. 8 and 9, where the packaging interior V is shown as being closed by a lid 112. For example, the packaging interior V may be closed by the lid 112 by applying heat sealing or ultrasonic sealing.

For this, the packaging interior V may be delimited by a packaging wall 110 that forms at least part of the food packaging 100. For example, in the FIGS. 10 and 11, the packaging wall 110 is exemplarily illustrated as defining a single body of the food packaging 100. In comparison, the food packaging 100 exemplarily illustrated in FIGS. 8 and 9 comprises at least two packaging walls 110, one of which may form the lid 112 while the other one of the packaging walls 110 may form the body of the tray 101.

Therein, the packaging wall 110 may generally enclose or surround the packaging interior V such that an opening (in the body) to the space (e.g. the packaging interior V in FIGS. 8 to 11) may be provided with an opening preferably to one side.

The body of the food packaging 100 may be rigid or flexible. The configuration of the body may depend, for example, on the food packaging application and/or the intended content of the food packaging 100. For example, the body of the food packaging 100 may be provided as being rigid for the food packaging 100 being a food tray 101 or a capsule. In comparison, the body of the food packaging 100 may be provided as being flexible for the food packaging 100 being a pouch or a wrap.

Generally, the body of the food packaging 100 may be provided as a single-piece or may consist of one or more (single-piece) half-shells that may be bonded (e.g. sealed) together. For example, the food packaging 100 exemplarily illustrated in FIG. 11 may be a bottle 103 that may be made from a cellulosic molded pulp, and/or may be made of two half-shells (half-bottles) or may be a single piece. The bottle 103 may be closed by a lid, such as a screw cap. Similarly, the food tray 101 as exemplarily illustrated in FIGS. 8 and 9, respectively, may be manufactured also from a molded cellulosic pulp and/or may be a single piece, for instance. The cup 102, which is exemplarily illustrated in FIG. 10, may be made from carton and/or may be a single piece. The tray 101 and the cup 102 may be closed by the lid 112, which preferably may be made from carton, for example.

At least a portion 111 of the food packaging 100 that delimits at least part of the packaging interior V is impregnated with a polymer 300. This is exemplarily illustrated in FIGS. 4 to 11.

For example, a solid impregnation process, liquid impregnation process, or a vacuum impregnation process can be used for this purpose. The different steps of the impregnation process are exemplarily illustrated in FIGS. 1 to 3. Therein, it is exemplarily illustrated how the gaps 201 between the fibres of the cellulosic fibrous material 200 (as illustrated in FIG. 1) can be filled with particles of the polymer 300. This is exemplarily illustrated in FIG. 2. Then the polymer 300 and the cellulosic fibrous material 200 can be bonded together to form a preferably contiguous impregnated material 230 (e.g. by heat treatment or other treatment methods). This is exemplarily illustrated in FIG. 3.

Therein, the polymer 300 may preferably be a food grade material. Alternatively or additionally, the polymer 300 may be biodegradable. Preferably, the polymer 300 may be provided as a powder and/or may be soluble in a solvent. Advantageously, the polymer 300 may have a refractive index similar or identical to the cellulosic fibrous material 200. For example, the polymer 300 and the cellulosic fibrous material 200 may have both a refractive index of 1.5. Accordingly, the resulting refractive index of the impregnated material 230 may be uniform.

Suitable material choices for the polymer 300 may be, for example, a Polyolefin, Polyacrylate, Polycaprolactone (PCL), Polyester, Polyalcohol, Polyhydroxyalkanoate (PHA), thermoplastic starch (TPS), cellulose derivative, Epoxy resin, or any combination thereof.

Polethylene (PE) or Polypropylene (PP) may be used as a Polyolefin for the polymer 300.

It is also conceivable to use (additionally or alternatively) Polyethylene terephthalate (PET), polybutylene adipate terephthalate (PBAT), polylactic acid (PLA) and/or Polybutylene succinate-co-butylene adipate (PBSA) as a Polyester for the polymer 300.

Further, cellulose acetate (CA), cellulose acetate-butyrate (CAB), cellulose acetate-propionate (CAP), carboxymethyl cellulose acetate butyrate (CMCAB), and/or hydroxy methyl ethyl cellulose (HMEC) may be (additionally or alternatively) used as a cellulose derivative for the polymer 300.

Moreover, Polyvinyl alcohol (PVOH), Butenediol Vinyl Alcohol Co-polymer (BVOH), Polyvinylacetate (PVAC, PVA) may be (additionally or alternatively) used as a Polyalcohol for the polymer 300.

Polyhydroxybutyrate (PHB), polyhydroxyvalerate (PHV), Poly(3-hydroxybutyrate-co-3-hydroxyvalerate) (PHBV), and/or PHBH (a random copolymer of (R)-3-hydroxybutyrate (3HB) and (R)-3-hydroxyhexanoate (3HHx)) may be (additionally or alternatively) used as a polyhydroxyalkanoate (PHA) for the polymer 300.

The at least one packaging wall 110 may comprise the impregnated portion 111. Therein, the impregnated portion 111 may be integrally formed with the at least one packaging wall 110. This is exemplarily illustrated in all Figures.

The impregnated portion 111 may be provided anywhere on the food packaging 100. For example, the impregnated portion 111 may be comprised by the lid 112 of the food packaging 100 as exemplarily illustrated in FIG. 8. Alternatively or additionally, the body of the food packaging 100 may comprise the impregnated portion 111, such as exemplarily illustrated in FIGS. 9 to 11. Naturally, it is also conceivable that the food packaging 100 may comprise more than one impregnated portion 111, as exemplarily shown in FIGS. 8 and 10.

The portion 111 of the food packaging 100 is impregnated with the polymer 300 such that the impregnated portion 111 has a (direct) light transmittance above 60% for visible light. Thereby, the cellulosic fibrous material 200 can be provided with an integral transparent field.

Generally, the transparency of the impregnated portion 111 may increase as the impregnation of the cellulosic fibrous material 200 increases. Alternatively or additionally, the transparency of the impregnated portion 111 may increase with increasing uniformity of the polymer 300 distribution in the cellulosic fibrous material 200. Similarly, the transparency of the impregnated portion 111 may increase with increasing approximation of the refractive index of the polymer 300 onto the refractive index of the cellulosic fibrous material 200.

Accordingly, the impregnated portion 111 may have a light transmittance above 65%, or above 70%, or above 75%, or above 80%, or above 85%, or above 90%, or above 95%, or 100% for visible light.

Therein, the transparency may be measured in line with industrial standards, such as ASTM D 1746-03. Therein, for example, the light transmittance may be calculated as a percent ratio of the light intensity with a specimen, such as the impregnated portion 111, being placed in a test light beam and compared to the light intensity with no specimen in the test light beam.

As illustrated exemplarily in FIGS. 4 to 11, the impregnated portion(s) 111 may form one or more windows for displaying a food product being placed inside the food packaging 100 in the packaging interior V.

Preferably, the food product may be placed in relative proximity to the impregnated portion 111. For example, the distance between the impregnated portion 111 and the food product may be below 1 mm, or below 2 mm, or below 3 mm, or below 4 mm, or below 5 mm, or below 10 mm, or below 15 mm, or below 20 mm, or below 30 mm, or below 40 mm, or below 50 mm.

Preferably, the impregnated portion 111 may comprise a concentration of the polymer 300 that may be continuous. This is exemplarily illustrated in FIG. 4.

Alternatively or additionally, it also conceivable that the impregnated portion may be at least partially continuous, such as exemplarily illustrated in FIGS. 6 and 7. In FIG. 6, for example, the impregnated portion 111 may alternate between sections of the packaging wall 110 that either comprise a high concentration of the polymer 300 and a section 235 that may comprise a lower or no concentration of the polymer 300. In FIG. 7, for example, the concentration of the polymer 300 may vary for longitudinally or laterally different sections 231, 232, 233 of the packaging wall 110 while the concentration of the polymer 300 within each of individual section 231, 232, 233 may be constant. Therein, in FIG. 7 different patterns are used to illustrate different concentrations.

Moreover, it is also conceivable that at the impregnated portion 111 the concentration of the polymer 300 may vary along its extension direction that defines the thickness of the impregnated portion 111 (e.g. the direction from the packaging interior V to the outside of the food packaging 100). This is exemplarily illustrated in the schematic sectional side view of FIG. 5. Therein, the concentration of the polymer 300 may vary for (radially) different sections 231, 232, 233, 234 of the packaging wall 110 at the impregnated portion 111 while the concentration of the polymer 300 within each of individual section 231, 232, 233 may be constant. Therein, in FIG. 5 different patterns are used to illustrate different concentrations.

Furthermore, it is conceivable, for example, that the cellulosic fibrous material 200 may be impregnated with a gradient of impregnation between one and the other of its sides (e.g. thickness or lateral direction). In this case, one side of the impregnated material 230 may comprise a higher concentration of the polymer 300 than the other. This is exemplarily illustrated in FIGS. 5 and 7. By providing the polymer 300 as a sealable polymer, it can be possible that the side of the impregnated material 230, which comprises a higher concentration of the polymer 300 than the other opposite side, may be heat-sealable. Thereby, the impregnated material 300 may be used for forming a three-dimensional packaging, such as the food packaging 100, from a flat sheet.

Alternatively or additionally, the impregnated portion 111 may comprise at least one sealing portion having a concentration of the polymer 300 that allows for sealing the impregnated portion 111 by heat sealing and/or ultrasonic sealing. A sealable polymer may be used, which may be different from or identical with the polymer 300. Preferably, the sealing portion may be provided at one side of the impregnated portion 111 that comprises a higher concentration of the polymer 300 than a respective other opposite side.

As mentioned before, the food packaging 100 may comprise a plurality of the impregnated portions 111. As illustrated exemplarily in FIG. 6, at least some of the impregnated portions 111 can be provided separated from each other by one or more sections 235 of the food packaging 100 comprising a lower or no concentration of the polymer 300 in comparison to said impregnated portions 111.

Alternatively or additionally, the impregnated portion 111 may extend across the entire food packaging 100 as exemplarily illustrated in FIG. 4.

Preferably, the food packaging 100 and/or at least the impregnated portion 111 may comprise an oxygen barrier. For example, the oxygen transmission rate of the (entire) food packaging 100 may be below 5 cm³/m²/day (measured at 23° C. and 50% Relative Humidity).

Alternatively or additionally, the food packaging 100 and/or at least the impregnated portion 111 may comprise a grease barrier. For example, the kit test value received in a standard grease degree repellence test may be above 10 (with the achievable maximum being 12).

Alternatively or additionally, the food packaging 100 and/or at least the impregnated portion 111 may comprise a moisture barrier. For example, the moisture transmission rate of the food packaging 100 may be below 5 g/m²/day (measured at 23° C./85% relative humidity).

Generally, the food packaging 100 may be configured such that it (despite the provision of barriers and/or the impregnated portion 111) may comprise more than 70 wt %, or 75 wt %, or 80 wt %, or 85 wt %, or 90 wt %, or 95 wt % of cellulose. In particular, the food packaging 100 may be configured in its constitution such that it may be (entirely or all of its components) recyclable preferably in the paper recycling stream, and/or such that it may be (entirely or all of its components) biodegradable.

The food packaging 100 and/or at least the impregnated portion 111 may have a thickness (e.g. thickness of the packaging wall 110) that may be 5 microns or above, 40 microns or above, 0.1 mm or above, 0.5 mm or above, 1 mm or above, 2 mm or above, 3 mm or above, 4 mm or above, 5 mm or below, 4 mm or below, 3 mm or below, 2 mm or below, 1 mm or below, 0.5 mm or below, 0.1 mm or below, or 40 microns or below, or any combination thereof.

Moreover, the food packaging 100 or, if present, the at least one packaging wall 110 may have a grammage between 30 g/m² and 800 g/m². More preferred, the food packaging 100 may have a grammage above 30 g/m², above 40 g/m², above 60 g/m², above 80 g/m², above 100 g/m², above 120 g/m², above 140 g/m², above 160 g/m², above 180 g/m², above 200 g/m², above 220 g/m², above 240 g/m², above 260 g/m², above 280 g/m², above 300 g/m², above 320 g/m², above 340 g/m², above 360 g/m², above 380 g/m², above 400 g/m², above 420 g/m², above 440 g/m², above 460 g/m², above 480 g/m², above 500 g/m², above 520 g/m², above 540 g/m², above 560 g/m², above 580 g/m², above 600 g/m², above 620 g/m², above 640 g/m², above 660 g/m², above 680 g/m², above 700 g/m², above 720 g/m², above 740 g/m², above 760 g/m², above 780 g/m², or of 800 g/m², and/or below 800 g/m², below 780 g/m², below 760 g/m², below 740 g/m², below 720 g/m², below 700 g/m², below 680 g/m², below 660 g/m², below 640 g/m², below 620 g/m², below 600 g/m², below 580 g/m², below 560 g/m², below 540 g/m², below 520 g/m², below 500 g/m², below 480 g/m², below 460 g/m², below 440 g/m², below 420 g/m², below 400 g/m², below 380 g/m², below 360 g/m², below 340 g/m², below 320 g/m², below 300 g/m², below 280 g/m², below 260 g/m², below 240 g/m², below 220 g/m², below 200 g/m², below 180 g/m², below 160 g/m², below 140 g/m², below 120 g/m², below 100 g/m², below 80 g/m², below 60 g/m², below 40 g/m², or of 30 g/m².

For example, the food packaging 100 may be manufactured in a process, which may comprise the steps of:

A forming step, where the body of the food packaging 100 may be formed such that the packaging interior V may be defined. For example, this may be done in a pulp molding process or with a formable cellulosic sheet material in a thermoforming process. Alternatively or additionally, the food packaging material may be folded and sealed together to form the body with the packaging interior V.

An impregnation step, where at least a portion of the material of (the body of) the food packaging 100 may be impregnated, for example in a solid impregnation process, to form the above-described impregnated portion 111 (comprising the impregnated material 230). Preferably, the impregnation step may be completed before or after the forming step.

A filling step, where the packaging interior V may be filled with the food product.

Finally, the packaging interior V may be sealed closed, e.g., by sealing the lid 112 onto the body, preferably via the sealing portions.

The invention is not limited by the embodiments as described hereinabove, as long as being covered by the appended claims. All the features of the embodiments described hereinabove can be combined in any possible way and be provided interchangeably.

1. A three-dimensional food packaging made of a cellulosic fibrous material and defining a packaging interior, wherein at least a portion of the food packaging defining at least part of the packaging interior is impregnated with a polymer such that the impregnated portion has a light transmittance above 60% for visible light.

2. The three-dimensional food packaging according to claim 1, wherein the impregnated portion has a light transmittance above 65% for visible light.

3. The three-dimensional food packaging according to claim 1, wherein the polymer is a food grade material, is biodegradable and has a refractive index similar or identical to the cellulosic fibrous material.

4. The three-dimensional food packaging according to claim 1, wherein the polymer is selected from the group consisting of Polyolefin, Polyacrylate, Polycaprolactone, Polyester, Polyalcohol, Polyhydroxyalkanoate, thermoplastic starch, cellulose derivative, Epoxy resin, and combinations thereof.

5. The three-dimensional food packaging according to claim 1, wherein the impregnated portion comprises a concentration of the polymer that is continuous along at least one of its extension directions.

6. The three-dimensional food packaging according to claim 1, wherein the impregnated portion comprises at least one sealing portion having a concentration of the polymer that allows for sealing the impregnated portion by heat sealing and/or ultrasonic sealing, wherein preferably the sealing portion is provided at one side of the impregnated portion that comprises a higher concentration of the polymer than a respective other opposite side.

7. The three-dimensional food packaging according to claim 1, wherein the food packaging comprises a plurality of the impregnated portions.

8. The three-dimensional food packaging according to claim 1, wherein the food packaging and/or at least the impregnated portion comprises an oxygen barrier, a grease barrier, and a moisture barrier.

9. The three-dimensional food packaging according to claim 1, wherein the food packaging and/or at least the impregnated portion has a thickness that is of 5 microns or above.

10. The three-dimensional food packaging according to claim 1, wherein the cellulosic fibrous material is selected from the group consisting of paper, paperboard, a cellulosic pulp adapted for being molded, a cellulose nanofibres sheet or film, airlaid cellulose and delignified wood.

11. The three-dimensional food packaging according to claim 1, wherein the food packaging comprises more than 70 wt % of cellulose.

12. The three-dimensional food packaging according to claim 1, wherein the impregnated portion forms at least one window for displaying a food product being placed inside the food packaging in the packaging interior.

13. The three-dimensional food packaging according to claim 1, wherein the food packaging comprises at least one packaging wall defining a body.

14. The three-dimensional food packaging according to claim 1, wherein the food packaging comprises a grammage between 30 g/m² and 800 g/m².

15. The three-dimensional food packaging according to claim 1, wherein the food packaging comprises a lid, the packaging interior is closed by the lid and
the food packaging sealingly encloses the packaging interior for containing an edible product for human and/or animal consumption.
